(19) United States
(12) Patent Application Publication
(10) Pub. No.: US 2015/0356650 A1
(43) Pub. Date: Dec. 10, 2015

(54) COST OPTIMIZATION OF PRODUCTS AND SERVICES USING COLLABORATIVE ORDER GROUPING

(71) Applicant: Volodymyr Vasyutynskyy, Dresden (DE)

(72) Inventor: Volodymyr Vasyutynskyy, Dresden (DE)

(21) Appl. No.: 14/298,442

(22) Filed: Jun. 6, 2014

(51) Int. Cl. G06Q 30/06

(52) U.S. Cl. CPC G06Q 30/0605; G06Q 30/0611

(57) ABSTRACT

Requests are received from each of a plurality of purchaser remote computing systems that each specifies at least one product or service to be provided to one of a plurality of purchasers. Based on the received requests a plurality of grouped orders can be generated that each group and aggregate products and services common to two or more of the received requests. At least one supplier that can offer products or services to fulfill the grouped order can be identified for each grouped order. Order solicitations for each grouped order can be transmitted to at least one supplier remote computing system associated with the corresponding identified at least one supplier. Bids to supply the products or services specified in the order solicitation can be received for each grouped order in response to the transmitted order solicitations. The bids can be parsed into proposals corresponding to each purchaser.

### TECHNICAL FIELD

The subject matter described herein relates to a collaboration platform that enables collaborative order grouping among various purchasers and suppliers.

### BACKGROUND

In many industries, there appears to be a trend for small or mid-sized companies to produce products or services independently for their relevant markets. Minimizing production costs can be extremely important for such small or mid-sized companies, in order to compete with other larger companies. However, the nature of the manufacturing process is such that the cost per unit for a small order can be significantly higher than the cost per unit of a large order of the same product. This scenario is because a typical manufacturing process requires an initial one-time setup investment for new products, or for switching between the manufacturing of different products, or for transportation. For example, different robots within a manufacturing plant need to be configured, or the workflow of new services need to be designed before beginning to manufacture a new product. Therefore, it follows that in many businesses the production costs per unit of product or service can decrease as the amount of produced units increase, also known as economy of scale. However, taking advantage of the concept of economy of scale is not easy for small or mid-sized companies, which do not have enough customers in their target areas or regions to achieve large orders that can take advantage of manufacturing economy of scale ordering. Furthermore, when juggling the costs and risks of carrying too much inventory with customer expectation of fast turn-around time after ordering a product, many companies have no choice other than to absorb the higher manufacturing costs of non-economy of scale manufacturing.

### SUMMARY

In one aspect, requests are received from each of a plurality of purchaser remote computing systems. Each request specifies at least one product or service to be provided to one of a plurality of purchasers. Based on the received requests a plurality of grouped orders can be generated. The grouped orders can each group and aggregate products and services common to two or more of the received requests. At least one supplier that can offer products or services to fulfill the grouped order can be identified for each grouped order. Order solicitations for each grouped order and based on the grouped order can be transmitted to at least one supplier remote computing system associated with the corresponding identified at least one supplier. Bids to supply the products or services specified in the order solicitation can be received for each grouped order in response to the transmitted order solicitations. The bids can be parsed into proposals corresponding to each purchaser. The proposals can be transmitted to the corresponding purchaser remote computing systems.

Each grouped order can anonymize identification information of each purchaser. Each request can specify completion conditions for provision of the corresponding at least one product or service. The completion conditions can include a maximal amount of units, a maximal order sum, and a maximal number of purchasers.

Each bid can specify delivery conditions for provision of the corresponding at least one product or service. The delivery conditions can include proposed delivery time, costs per unit, costs per unit based on volume, packaging type, and transportation type.

Data including one or more search terms can be received. Grouped orders matching the search terms can be identified. Data characterizing the identified grouped orders having matching search terms can be provided.

Variants for products or services requested in the received requests can be identified. A plurality of second grouped orders that each group and aggregate the identified variants can be generated based on the received requests and the identified variants. For each second grouped order, second order solicitations can be transmitted to at least one supplier remote computing system associated with the corresponding identified at least one supplier. In response to the transmitted second order solicitations, second bids can be received for each second grouped order, to supply the products or services specified in the order solicitation. The second bids can be parsed into second proposals corresponding to each purchaser, and second proposals can be transmitted to the corresponding purchaser remote computing systems.

Complementary products or services for at least one of the grouped orders can be identified. The corresponding order solicitations can include the identified complementary products and services.

Non-transitory computer program products (i.e., physically embodied computer program products) are also described that store instructions, which when executed on one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The current subject matter provides many advantages. For example, the current subject matter provides a platform where product suppliers and product purchases can coordinate and group like manufacturing needs of a number of companies requiring similar products together, in order to reduce manufacturing costs for each individual product purchaser.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a diagram of the system for implementing the collaboration platform that can group orders for reducing the costs of manufacturing;

FIG. 2 is a process flow chart illustrating order grouping in a collaboration platform when the collaboration is initiated by purchasers; and

FIG. 3 is a process flow chart illustrating order grouping in a collaboration platform when the collaboration is initiated by suppliers.

### DETAILED DESCRIPTION

The subject matter described herein provides a collaboration platform, which can support the grouping and batching of production orders of several companies, so that a supplier can manufacture a number of separate orders as a group, rather than individually. This arrangement facilitates optimization and cost reduction of products and service by reducing manufacturing costs. The cost reduction can be realized by taking advantage of the initial setup investments to produce a larger number of products by grouping orders from different purchasing companies. Therefore, the added value of the solution lays in manufacturing products a smaller per-unit price, thereby decreasing the production costs by producing big-size batches of the products from different purchasing companies. Furthermore, the collaboration platform can create a marketplace between purchasers and suppliers. This marketplace can create a competitive environment where participants of the collaboration platform can negotiate with each other, thereby reducing cost due to competition.

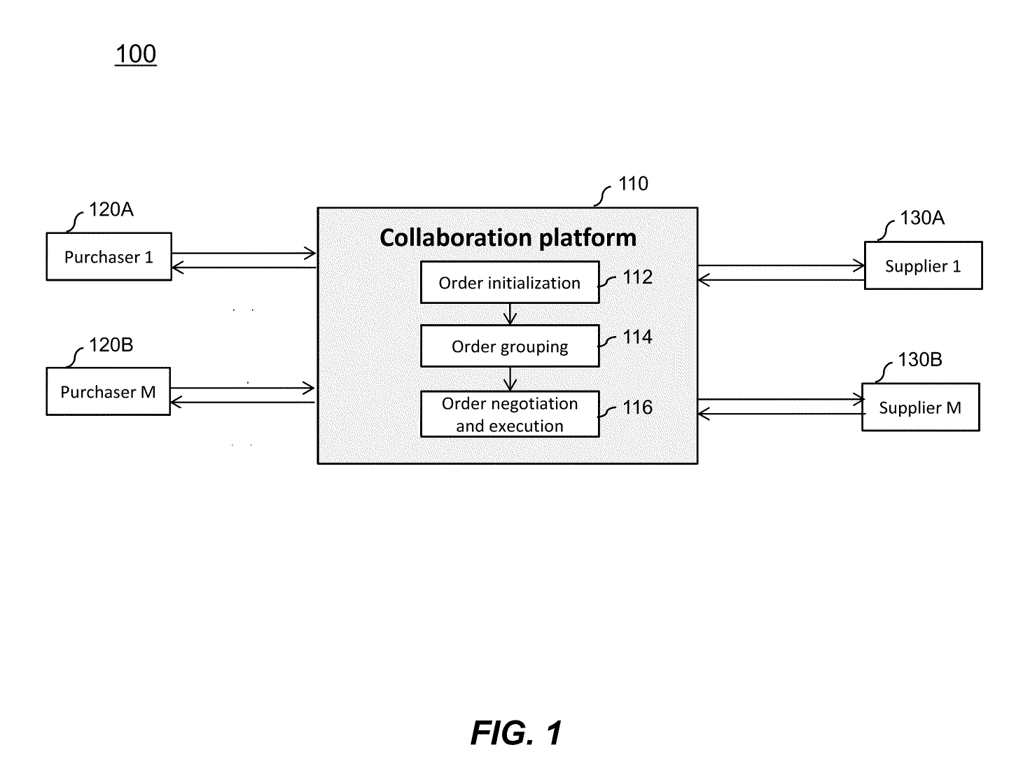

FIG. 1 is a diagram of a system 100 for implementing the collaboration platform that group orders in order to reduce the costs of manufacturing. It will be appreciated that other environments can be utilized including variations of the environments illustrated in FIG. 1. The system 100 can include at least one purchaser 120A, and another purchaser 120B, and at least one supplier 130A, and another supplier 130B, which can be computer servers remotely connected within a network, to a collaboration platform 110. The collaboration platform 110 can be a computer server implemented within a cloud.

The purchasers 120A, 120B and suppliers 130A, 130B can be client devices that can communicate wirelessly with the collaboration platform 110, and can include at least one processor and at least one memory. The collaboration platform 110 can also include a memory and processor for storing and processing data and information. The at least one purchaser 120A and at least one supplier 130A can be a mobile device, for example a mobile phone, a tablet computer, and such, and well as a computer terminal. Additionally, the purchasers 120A and suppliers 130A can include sensors that can include other technologies that can enable information to be easily collected by the purchasers 120A and suppliers 130A. These technologies include, for example, barcode scanners, radio frequency identification scanners, picture mapping recognition applications, and graphical user interface portals for manual data entry. Data acquired by the sensors can be collected by purchasers 120A and suppliers 130A using the processing units, and can be stored in memory on these computing devices.

In at least some variations, a purchaser 120A can initiate an order requesting a product by providing a request, which can contain data defining the criteria for the order requested by purchaser 120A. The requested product can include sub-products, materials, spare parts or services. The data in the request can include a description of the product with several parameters, for example, type or description (e.g. “screw”), size (“40×5” mm) or material (“steel” or “aluminum”). The data in the request can also include order completion conditions, which describe a set of conditions that can be required to be fulfilled in order to complete an order. The conditions can be linked up with AND or OR conjunctions. Examples of such conditions are the minimal lot size (e.g. 1000 pieces), maximal price (e.g. $0.50), and maximal number of purchasers or suppliers. The data in the request can further include additional conditions or descriptions, for example, shipping conditions, block pricing conditions (e.g. for an order of over 1000 pieces the cost is $0.50 per piece, or for an order of over 10,000 pieces the cost is $0.45 per piece), and preferred region of production or shipping, etc. The data in the request can further include additional metadata, for example the group of goods to which the product can belong. The data in the request can include definite parameters, as well as flexible parameters, for example bandwidths describing the minimal, average and maximal numbers depending on certain conditions.

As part of an order initialization step 112, the request defining an order can be sent by purchaser 120A to the collaboration platform 110. Upon receiving the request, the collaboration platform 110 can generate an initial grouped order based on the request received from purchaser 120A. The grouped order can then be published on the collaboration platform 110 and can be seen either by all platform participants (purchasers 120A, 120B and subscribers 130A and 130B), or by a subgroup of participants subscribed to a certain category of goods like “screws.” The visibility conditions can be defined by the purchaser 120A, by optionally defining an access control filtered view that can enable a subset of purchasers and suppliers to view the initial request from purchaser 120A, while preventing others from viewing it.

The purchaser 120A that initially sent a request, based upon a grouped order was generated can be considered a lead purchaser that can represent the interests of the grouped order. At a later stage, if other purchasers will join the grouped order, the leadership role can be succeeded to another purchaser, for example purchaser 120B.

The grouped order published on the collaboration platform 110, can be anonymized in order to keep some specific features of the order or purchaser anonymous to the other platform participants. This can be important for keeping the commercial secrets of purchasers and suppliers. In other variations, the some specific features of a supplier can be anonymized for similar reasons.

As part of an order grouping step 114, the participants of the collaboration platform 110 can view the available one or more grouped orders. The participants can use a search option, which can use product or service catalogues to find and associate corresponding order groupings. In this manner, corresponding order groupings can be joined into larger order groupings. In some variations, the collaboration platform 110 can support the search for corresponding order groupings for a product using search or recommendation functionalities. Additionally, notification functions can be defined, which actively notify the participants of potentially relevant new grouped orders. In some variations, a grouped order may define a request for a product similar to, but not identical to other products from other requests. Depending on similarities and differences, the orders can be grouped into one product batch for manufacturing. For example, if machines are able to produce similar products in one batch, despite their variances. The rules for the searching capabilities and allowed differences between products and services in order to promote order grouping can be defined by the suppliers and the purchasers. Upon viewing order groupings or searching for order groupings, purchasers or suppliers interested in the same or similar products can add their orders to the grouped order. Furthermore, the collaboration platform 110 can perform machine learning activities and can scan a history of previous order groupings that were batched together in order to learn from them. The collaboration platform 110 can propose order groupings to be batched together based on learned similar grouping behaviors.

The collaboration platform 110 can then identify a supplier 130A that is likely to be able to manufacture the batched grouped orders. This identification can be based on parameters related to the supplier, as well as based on search results matching the grouped orders and the supplier 130A. In other variations, the supplier 130A can be identified based on an expressed interest from the supplier 130A in a particular order grouping, or in a general criterion that a particular grouping order meets.

The collaboration platform 110 can transmit or present order solicitations to one or more identified suppliers 130A, 130B. The suppliers can analyze the order solicitation and can respond by sending one of more bids to the collaboration platforms 110. These bids can include offer negotiation points and can propose recommendations for reducing production costs. For example, the supplier can recommend that if an extra 200 units of a product can be added to a grouped order the cost per unit can reduce from $0.45 per item, to $0.35 per item.

Based on the recommendations in the bids, the grouped order proposal can be expanded with additional requests by different purchasers. Purchasers can adapt parameters of order groupings following the recommendations in the bids, in order to meet order proposal completion conditions, for example for achieving the maximal amount of produced units, maximal order sum, maximal number of purchasers, etc. After the bid recommendations have been met and confirmed by potential purchasers and suppliers, the order proposals can be delivered back to the purchasers. The order proposals may contain additional details like proposed delivery time, costs per units, collateral proposals (like packaging or transportation costs), etc. In some variations, prior to sending out the order proposals to the purchasers 120A, 120B, the order proposals are parsed and anonymized accordingly, corresponding to each relevant purchaser.

If an agreement cannot be reached, as part of an order negotiation and execution step 116, the purchasers can further negotiate by changing order grouping details that may not meet the exact recommendations of the bids. The negotiations can involve a number of back and forth communication iterations, including order requests, order solicitations, bids and proposals between the purchasers and the suppliers via the collaboration platform 110. In this step, the purchasers can change some details of the order groupings or can indicate their purchasing capacities. The collaboration platform 110 can support a one-to-many collaboration, for example between a number of potential purchasers 120A ad 120B, and a supplier 130A via direct messages. In other variations the collaboration platform 110 can support a many-to-many collaboration, for example between a number of potential purchasers 120A and 120B, and a number of potential suppliers 130A and 130B, for example via collaboration walls.

The negotiation step between participants can be considered as complete when the conditions of completing the order groupings are fulfilled or purchasers have agreed to finalize the order grouping. Upon completing negotiations, a purchaser 120A representing the batches of order groupings can contact the supplier and can further negotiate production and shipping details, which may take several negotiation rounds until the order can be considered as completed. These negotiations can include sending additional order solicitations to the suppliers, and the suppliers responding with additional bids in further negotiation. In some variations where the supplier 130A can be the initiator of an order grouping, it can be the supplier 130A that negotiates directly with purchasers 120A and 120B.

Upon the completion of all these negotiation rounds, the grouped order can be finalized using the collaboration platform 110 or other means, such as physical paper contracts, and the production and shipping process can begin.

In some variations, a supplier 130A can initiate a collaboration process by providing one or more initial bids for products, quantities and prices at which the supplier can supply a product. The bids can then be broken down and parsed into proposals according to criteria relevant to each of a plurality of purchasers 120A, 120B. The criteria used to break down the bids can include expressed interest in different products, services, or other parameters relating to products or services, previously provided by the purchasers 120A, 120B, and stored in memory at the collaboration platform 110. In other variations, the collaboration platform 110, through machine learning, can learn the purchasing trends of purchasers 120A, 120B, and can parse and breakdown bids into proposal requests, accordingly. The proposals can then be transmitted to each relevant purchaser 120A, 120B, accordingly. Based on the proposal requests, the purchasers can send their order requests. The collaboration platform 110 can use these requests and can perform similar negotiations using order solicitations, as was described for the collaborations that were initiated by the purchasers.

In some variations, the collaboration platform 110 can receive revenue from the collaborations by charging a fee for each communication between participants. Alternatively, collaboration platform 110 can receive revenue by charging a percentage of the agreed upon price for a collaboration.

An example of a collaboration using the collaboration platform 110 can be provided as follows. The purchaser 120A can provide a request for producing 500 units of the product A, and can generate an initial grouped order. The purchaser 120B can find this request on the collaboration platform 110 and can add a further 700 units to the grouped order. Due to a larger amount of units in the grouped order, the cost per unit can be decreased from $8 to $5 per unit at supplier 130A. After confirmation by the supplier 130A, the purchaser 120A and purchaser 120B can confirm and agree to process the grouped order. Thereafter, the collaboration platform 110 can also proposes two collateral services of transportation to purchaser 120A and purchaser 120B.

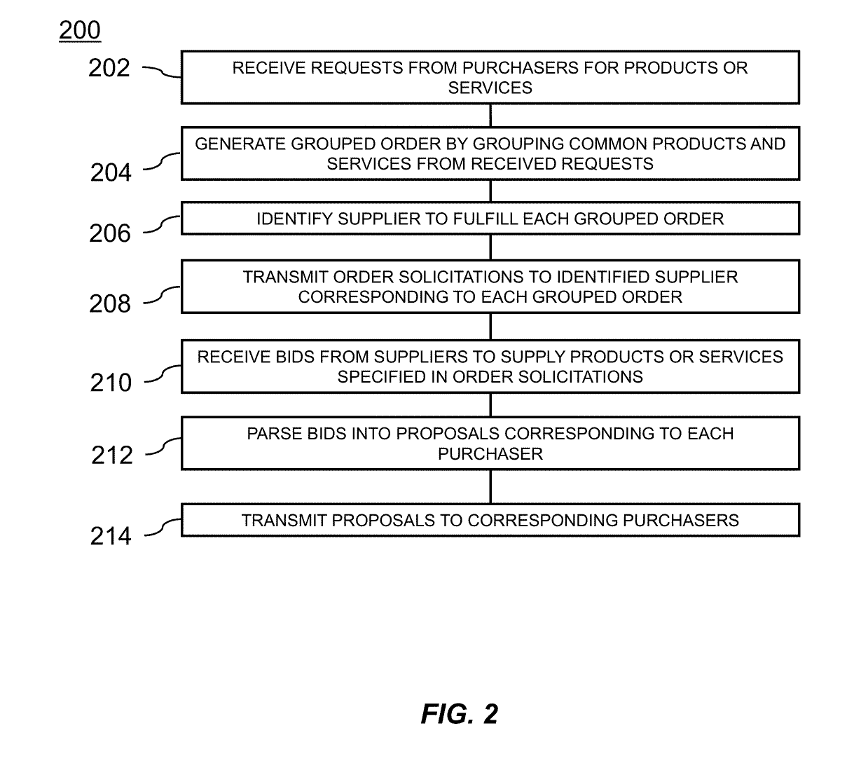

FIG. 2 is a process flow chart 200 illustrating order grouping in a collaboration platform when the collaboration is initiated by purchasers. At 202, a collaboration platform can receive a request to purchase a product or service from a purchaser, of a plurality of purchasers. At 204, the collaboration platform can generate at least one grouped order by grouping common products and services from received requests. At 206, the collaboration platform can identify a supplier to fulfill each grouped order. At 208, the collaboration platform can transmit order solicitations to the identified supplier corresponding to each grouped order. At 210, the collaboration platform can receive bids from the supplier to supply the products or services specified in the order solicitations. At 212, the collaboration platform can parse the bids into proposals corresponding to each purchaser. At 214, the collaboration platform can transmit the proposals to the corresponding purchasers.

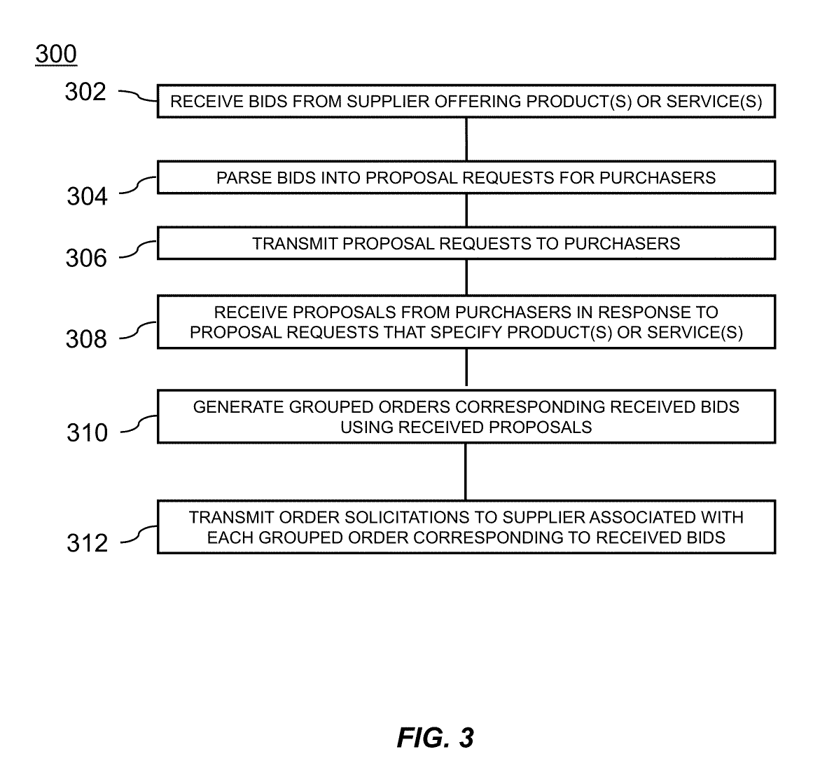

FIG. 3 is a process flow chart 300 illustrating order grouping in a collaboration platform when the collaboration is initiated by suppliers. At 302, a collaboration platform can receive bids from at least one supplier offering to supply at least one product or service. At 304, the collaboration platform can parse the bids into proposal requests for a plurality of purchasers, and at 306, the collaboration platform can transmit the proposal requests to the purchasers. At 308, the collaboration platform can receive proposals from a plurality of purchasers in response to the proposal requests, specifying at least one product or service to be purchased. At 310, the collaboration platform can generate grouped orders corresponding to the received bids using the received proposals, where the grouped orders group and aggregate products and services common to two or more received proposals. At 312, the collaboration platform can transmit order solicitations to the supplier associated with each grouped order corresponding to the received bids.

One or more aspects or features of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device (e.g., mouse, touch screen, etc.), and at least one output device.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” (sometimes referred to as a computer program product) refers to physically embodied apparatus and/or device, such as for example magnetic discs, optical disks, memory, and Programmable Logic Devices (PLDs), used to provide machine instructions and/or data to a programmable data processor, including a machine-readable medium that receives machine instructions as a machine-readable signal. The term “machine-readable signal” refers to any signal used to provide machine instructions and/or data to a programmable data processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. For example, the current subject matter can be implemented using row store disk databases. In particular, further features and/or variations can be provided in addition to those set forth herein. For example, the implementations described above can be directed to various combinations and subcombinations of the disclosed features and/or combinations and subcombinations of several further features disclosed above. In addition, the logic flow(s) depicted in the accompanying figures and/or described herein do not necessarily require the particular order shown, or sequential order, to achieve desirable results. Other implementations may be within the scope of the following claims.

What is claimed is:

1. A method for implementation by one or more data processors forming part of at least one computing system, the method comprising:
receiving requests from each of a plurality of purchaser remote computing systems, each request specifying at least one product or service to be provided to one of a plurality of purchasers;
generating, based on the received requests, a plurality of grouped orders that each group and aggregate products and services common to two or more requests;
identifying, for each grouped order, at least one supplier offering products or services to fulfill the grouped order;
transmitting, for each grouped order and based on the grouped order, order solicitations to at least one supplier remote computing system associated with the corresponding identified at least one supplier;
receiving, for each grouped order in response to the transmitted order solicitations, bids to supply the products or services specified in the order solicitation;
parsing the bids into proposals corresponding to each purchaser; and
transmitting the proposals to the corresponding purchaser remote computing systems.

2. The method of claim 1, wherein each grouped order anonymizes identification information of each purchaser.

3. The method of claim 1, wherein each request specifies completion conditions for provision of the corresponding at least one product or service.

4. The method of claim 3, wherein the completion conditions are selected from a group consisting of: a maximal amount of units, a maximal order sum, and a maximal number of purchasers.

5. The method of claim 1, wherein each bid specifies delivery conditions for provision of the corresponding at least one product or service.

6. The method of claim 5, wherein the delivery conditions are selected from a group consisting of: proposed delivery time, costs per unit, costs per unit based on volume, packaging type, and transportation type.

7. The method of claim 1 further comprising:
receiving data comprising one or more search terms;
identifying grouped orders matching the search terms; and
providing data characterizing the identified grouped orders having matching search terms.

8. The method of claim 1 further comprising:
identifying variants for products or services requested in the received requests;
generating, based on the received requests and the identified variants, a plurality of second grouped orders that each group and aggregate the identified variants; and
transmitting, for each second grouped order, second order solicitations to at least one supplier remote computing system associated with the corresponding identified at least one supplier;
receiving, for each second grouped order in response to the transmitted second order solicitations, second bids to supply the products or services specified in the order solicitation;
parsing the second bids into second proposals corresponding to each purchaser; and
transmitting the second proposals to the corresponding purchaser remote computing systems.

9. The method of claim 1 further comprising:
identifying complementary products or services for at least one of the grouped orders, wherein the corresponding order solicitations include the identified complementary products and services.

10. A method for implementation by one or more data processors forming part of at least one computing system, the method comprising:
receiving bids from at least one supplier remote computing system, each bid offering at least one product or service that can be supplied by one of a plurality of suppliers;
parsing and breaking down the bids into proposal requests corresponding to a plurality of purchasers;
transmitting the proposal requests to each purchaser remote computing system corresponding to each associated purchaser;
receiving, in response to the proposal requests, proposals from a plurality of purchaser remote computing systems, each proposal specifying at least one product or service to be provided to one of a plurality of purchasers;
generating a plurality of grouped orders corresponding to the received bids using the received proposals, wherein the grouped orders each group and aggregate products and services common to two or more received proposals; and
transmitting, for each grouped order corresponding to the received bids, order solicitations to the supplier remote computing system associated with the corresponding identified at least one supplier.

11. A non-transitory computer program product storing instructions which, when executed by at least one data processor forming part of at least one computing system, result in operations comprising:
receiving requests from each of a plurality of purchaser remote computing systems, each request specifying at least one product or service to be provided to one of a plurality of purchasers;
generating, based on the received requests, a plurality of grouped orders that each group and aggregate products and services common to two or more requests;
identifying, for each grouped order, at least one supplier offering products or services to fulfill the grouped order;
transmitting, for each grouped order and based on the grouped order, order solicitations to at least one supplier remote computing system associated with the corresponding identified at least one supplier;
receiving, for each grouped order in response to the transmitted order solicitations, bids to supply the products or services specified in the order solicitation;
parsing the bids into proposals corresponding to each purchaser; and
transmitting the proposals to the corresponding purchaser remote computing systems.

12. The non-transitory computer program product as in claim 11, wherein each grouped order anonymizes identification information of each purchaser.

13. The non-transitory computer program product as in claim 11, wherein each request specifies completion conditions for provision of the corresponding at least one product or service.

14. The non-transitory computer program product as in claim 13, wherein the completion conditions are selected from a group consisting of: a maximal amount of units, a maximal order sum, and a maximal number of purchasers.

15. The non-transitory computer program product as in claim 11, wherein each bid specifies delivery conditions for provision of the corresponding at least one product or service.

16. The non-transitory computer program product as in claim 15, wherein the delivery conditions are selected from a group consisting of: proposed delivery time, costs per unit, costs per unit based on volume, packaging type, and transportation type.

17. The non-transitory computer program product as in claim 11 further comprising:
receiving data comprising one or more search terms;
identifying grouped orders matching the search terms; and
providing data characterizing the identified grouped orders having matching search terms.

18. The non-transitory computer program product as in claim 11 further comprising:
identifying variants for products or services requested in the received requests;
generating, based on the received requests and the identified variants, a plurality of second grouped orders that each group and aggregate the identified variants; and
transmitting, for each second grouped order, second order solicitations to at least one supplier remote computing system associated with the corresponding identified at least one supplier;
receiving, for each second grouped order in response to the transmitted second order solicitations, second bids to supply the products or services specified in the order solicitation;
parsing the second bids into second proposals corresponding to each purchaser; and
transmitting the second proposals to the corresponding purchaser remote computing systems.

19. The non-transitory computer program product as in claim 11 further comprising:
identifying complementary products or services for at least one of the grouped orders, wherein the corresponding order solicitations include the identified complementary products and services.
